(19) United States
(12) Patent Application Publication
(10) Pub. No.: US 2016/0104426 A1
(43) Pub. Date: Apr. 14, 2016

(54) DISPLAY APPARATUS HAVING A VOLTAGE CONNECTING LINE

(71) Applicant: SAMSUNG DISPLAY CO., LTD., YONGIN-CITY (KR)

(72) Inventors: Jong-Won CHOO, Gyeonggi-do (KR); Hyoung-Rae Lee, Chungcheongnam-do (KR); Mun-Ju Kim, Chungcheongnam-do (KR); Eun-Suk Kim, Chungcheongnam-do (KR); Seok-Kun Yoon, Gyeonggi-do (KR); Kwang-Youl Lee, Chungcheongnam-do (KR)

(21) Appl. No.: 14/701,994

(22) Filed: May 1, 2015

(30) Foreign Application Priority Data
Oct. 13, 2014 (KR) 10-2014-0137801

(51) Int. Cl. G09G 3/32

(52) U.S. Cl. CPC G09G 3/3258; G09G 2300/08; G09G 2320/0204

(57) ABSTRACT

A display apparatus includes a display panel including a gate line disposed in a display area and extending in a first direction, a data line extending in a second direction crossing the first direction and a switching element electrically connected to the gate line and the data line. A first data driving part is electrically connected to a first peripheral area adjacent to the display area. A second data driving part is electrically connected to a second peripheral area adjacent to the first peripheral area. The display panel includes a voltage connecting line disposed between the first peripheral area and the second peripheral area. The voltage connecting line connects the first data driving part to the second data driving part.

### CROSS-REFERENCE TO RELATED APPLICATION

This application claims priority under 35 U.S.C. §119 to Korean Patent Application No. 10-2014-0137801, filed on Oct. 13, 2014 in the Korean Intellectual Property Office (KIPO), the disclosure of which is incorporated by reference herein in its entirety.

### TECHNICAL FIELD

Exemplary embodiments of the present inventive concept relate to a display apparatus. More particularly, exemplary embodiments of the present inventive concept relate to a display apparatus having a voltage connecting line.

### DISCUSSION OF RELATED ART

A flat display apparatus such as an organic electroluminescence display apparatus may have a large-screen display with a high resolution. For example, a display apparatus may include an array substrate including pixel electrodes arranged in a matrix configuration, an opposing substrate facing the array substrate, and a liquid crystal layer disposed between the array substrate and the opposing substrate. The display apparatus may include a driver for applying a voltage to the pixel electrodes. For example, the driver may include a circuit part for controlling an image signal.

As a size of the flat display panel increases, the number of signal lines may also increase. A number of circuit boards included in a circuit part for providing electric signals to the signal lines may also increase.

The flat display apparatus may include a display panel configured to display an image, a driving circuit connected to the display panel and a source printed circuit board for applying a signal to the driving circuit. A mega flat display apparatus may include more than two source printed circuit boards. Therefore, the mega flat display apparatus may include additional flexible printed circuit boards for connecting the two source printed circuit boards to each other.

However, the flexible printed circuit boards may have a high resistance, and a voltage drop in the flexible printed circuit boards may be relatively large. Accordingly, an image defect at a front and a back of the flexible printed circuit boards may occur.

### SUMMARY

Exemplary embodiments of the present inventive concept provide a display apparatus capable of decreasing a defect on a display panel.

In an exemplary embodiment of the present inventive concept, the display apparatus includes a display panel including a gate line disposed in a display area and extending in a first direction, a data line extending in a second direction crossing the first direction and a switching element electrically connected to the gate line and the data line. A first data driving part is electrically connected to a first peripheral area adjacent to the display area. A second data driving part is electrically connected to a second peripheral area adjacent to the first peripheral area. The display panel includes a voltage connecting line disposed between the first peripheral area and the second peripheral area. The voltage connecting line connects the first data driving and the second data driving.

In an exemplary embodiment of the present inventive concept, the voltage connecting line may be disposed in the same layer as the gate line.

In an exemplary embodiment of the present inventive concept, the first and the second data driving parts may include a base substrate and a plurality of driving lines disposed on the base substrate.

In an exemplary embodiment of the present inventive concept, the base substrate may be a flexible substrate.

In an exemplary embodiment of the present inventive concept, the display apparatus may include a first printed circuit board electrically connected to the first data driving part and a second printed circuit board disposed adjacent to the first printed circuit board. The second printed circuit board may be electrically connected to the second data driving part.

In an exemplary embodiment of the present inventive concept, the first printed circuit board may include a first base substrate and a first line disposed on the first base substrate. The first line may be electrically connected to the first data driving part.

In an exemplary embodiment of the present inventive concept, the second printed circuit board may include a second base substrate and a second line. The second line may be electrically connected to the second data driving part. A third line may be disposed on the second base substrate, and may be parallel with the second line.

In an exemplary embodiment of the present inventive concept, the voltage connecting line may connect the first line and the second line.

In an exemplary embodiment of the present inventive concept, the display apparatus may include a connecting circuit board connecting the first printed circuit board and the second printed circuit board.

In an exemplary embodiment of the present inventive concept, the connecting circuit board may connect the first line and the third line.

In an exemplary embodiment of the present inventive concept, the first line, the second line and the third line may be configured to receive an analog driving voltage.

In an exemplary embodiment of the present inventive concept, the first printed circuit board may include a first connector disposed on the first base substrate. The second printed circuit board may include a second connector disposed on the second base substrate.

In an exemplary embodiment of the present inventive concept, the connecting circuit board may include a third base substrate and a connecting line disposed on the third base substrate.

In an exemplary embodiment of the present inventive concept, the third base substrate may be a flexible substrate.

In an exemplary embodiment of the present inventive concept, the connecting line may include a first connecting line extending in the first direction and a second connecting line extending in the second direction from an end of the first connecting line.

In an exemplary embodiment of the present inventive concept, a width of the connecting line may be greater than a width of the voltage connecting line.

In an exemplary embodiment of the present inventive concept, the display apparatus may further include a backlight assembly disposed under the display panel.

In an exemplary embodiment of the present inventive concept, the backlight assembly may include a light source configured to emit light and a light guide plate configured to guide the light emitted from the light source.

In an exemplary embodiment of the present inventive concept, the display apparatus may further include a mold frame configured to receive the backlight assembly.

In an exemplary embodiment of the present inventive concept, the display apparatus may further include a lower receiving container configured to receive the display panel and the backlight assembly.

### BRIEF DESCRIPTION OF THE DRAWINGS

The above and other features of the present inventive concept will become more apparent by describing in detail exemplary embodiments thereof with reference to the accompanying drawings, in which:

FIG. 1 is a plan view illustrating a display apparatus according to an exemplary embodiment of the present inventive concept;

FIG. 2 is a perspective view illustrating a display panel of FIG. 1;

FIG. 3 is a plan view magnifying a voltage connecting line of area ‘A’ of FIG. 2;

FIG. 4 is a plan view magnifying a first data driving part and a second data driving part of the area ‘A’ of FIG. 2;

FIG. 5 is a plan view illustrating a display apparatus according to an exemplary embodiment of the present inventive concept;

FIG. 6 is a perspective view illustrating a display panel of FIG. 5;

FIG. 7 is a plan view magnifying a voltage connecting line of the area ‘B’ of FIG. 6; and

FIG. 8 is a plan view magnifying a first data driving part and a second data driving part of the area ‘B’ of FIG. 6.

### DETAILED DESCRIPTION OF THE EMBODIMENTS

Hereinafter, exemplary embodiments of the present inventive concept will be described in more detail with reference to the accompanying drawings.

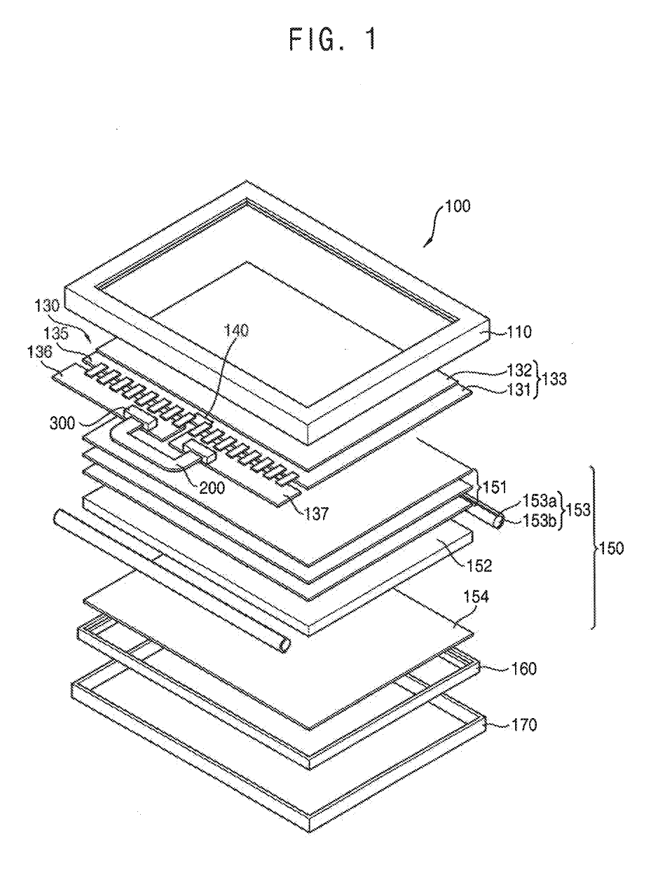

FIG. 1 is a plan view illustrating a display apparatus according to an exemplary embodiment of the present inventive concept.

Referring to FIG. 1, a display apparatus 100 may include a display panel assembly 130, a backlight assembly 150, a mold frame 160, a lower receiving container 170 and an upper receiving container 110.

The display panel assembly 130 may include a display panel 133, a data driving part 135, a first printed circuit board 136 and a second printed circuit board 137. The display panel 133 may display an image. The data driving part 135 may be disposed at an end of the display panel 133. The data driving part 135 may drive the display panel 133. The first printed circuit board 136 may provide a driving signal and a control signal to the display panel 133. A connecting circuit board 200 may electrically connect the first printed circuit board 136 and the second printed circuit board 137.

The first printed circuit board 136 and the second printed circuit board 137 may be electrically connected to each other by the connecting circuit board 200. According to an exemplary embodiment of the present inventive concept, the connecting circuit board 200 may be a flexible printed circuit (“FPC”). The connecting circuit board 200 may include a flexible and insulating material, such as a polyimide. The connecting circuit board 200 may include a plurality of conductive lines disposed on a base film. The connecting circuit board 200 may include a wiring pattern including the conductive lines and a connecting part for connecting to an external apparatus.

The display panel 133 may include a first display panel 131 and a second display panel 132. A liquid crystal layer may be disposed between the first display panel 131 and the second display panel 132.

The first display panel 131 may include one or more gate lines, one or more data lines, a pixel electrode and/or a thin film transistor. The thin film transistor may be connected to the gate line and the data line. The pixel electrode may be connected to the thin film transistor. A plurality of gate lines may extend along a first direction and may be spaced apart from each other. A plurality of data lines may extend along a second direction. The second direction may cross the first direction. The data lines may be spaced apart from each other. The pixel electrode may be disposed in a pixel region of the display panel 133. In an exemplary embodiment of the present inventive concept, a pixel region may be defined by the gate lines and the data lines arranged in a matrix form, but the inventive concept is not limited thereto or thereby. The thin film transistor may be switched (e.g., on and off) by the data line to transfer a signal from the data line to the pixel electrode. The second display panel 132 may include a light blocking pattern, a red, green and blue (“RGB”) color filter pattern and a common electrode. The light blocking pattern may block a transmission of light in a region of the display panel 133 except for the pixel region. The RGB color filter pattern may convert the light to colored light. The common electrode may generate an image.

The first display panel 131 and the second display panel 132 may be spaced apart from each other in a cross-sectional direction. An optically anisotropic liquid crystal layer may be disposed between first display panel 131 and the second display panel 132, but the inventive concept is not limited to the optically anisotropic liquid crystal layer.

The first printed circuit board 136 and second printed circuit board 137 may be disposed at an end of the display panel 133. The first printed circuit board 136 and second printed circuit board 137 may be connected to the display panel 133 through the data driving part 135. A driving integrated circuit (“IC”) may be disposed at substantially a center of the data driving part 135. The driving IC may drive the display panel 133.

The first printed circuit board 136 and the second printed circuit board 137 may be electrically connected to the data driving part 135. The data driving part 135 may be disposed on a relatively longer side of the display panel 133. The second printed circuit board 137 may be disposed adjacent to the first printed circuit board 136 in a direction parallel to the longer side of the display panel 133. A plurality of electronic components for generating a driving signal and a control signal may be disposed on the first printed circuit board 136 and the second printed circuit board 137. The connecting circuit board 200 may electrically connect the first printed circuit board 136 and the second printed circuit board 137.

The first printed circuit board 136 and the second printed circuit board 137 may be grounded to the upper receiving container 110 and/or the lower receiving container 170 to reduce or effectively prevent false operation of the display apparatus 100 due to electromagnetic wave interference. The first printed circuit board 136 and/or the second printed circuit board 137 may be bent along the lower receiving container 170 to be disposed on a back surface of the lower receiving container 170 and the display apparatus 100. The lower receiving container 170 may include a metal material. When the first and second printed circuit boards 136 and 137 are bent along the lower receiving container 170, the first printed circuit board 136 may be in contact with a side wall of the lower receiving container 170 and the second printed circuit board 137 may be in contact with the back surface of the lower receiving container 170, so that an extent of the grounding may be increased.

The connecting circuit board 200 may be connected to the first printed circuit board 136 and the second printed circuit board 137 by a connector 300. The connector 300 may be disposed on the first printed circuit board 136 and the second printed circuit board 137. A connecting part of the connecting circuit board 200 may be inserted into the connector 300 to connect the connecting circuit board 200 to the first printed circuit board 136 and the second printed circuit board 137.

The connecting circuit board 200 may be connected to the first printed circuit board 136 and the second printed circuit board 137 by an anisotropic conductive film (“ACF”).

As described above, the connecting circuit board 200 may be connected to the first printed circuit board 136 and the second printed circuit board 137 by the connector 300, but the present inventive concept is not limited thereto. In an exemplary embodiment of the present inventive concept, the connecting circuit board 200 may be connected to the first printed circuit board 136 and the second printed circuit board 137 by a connector assembly.

The backlight assembly 150, which may generate and provide light to the display panel 133, may be disposed under the display panel 133 in the cross-sectional direction. The backlight assembly 150 may include one or more light source units 153, a light guide plate 152, a reflecting sheet 154 and a plurality of optical sheets 151.

The light source unit 153 may be disposed on a side of the light guide plate 152, and may face a side surface of the light guide plate 152. The light source unit 153 may include one or more light sources 153b generating and providing light, and one or more light source covers 153a covering the one or more light sources 153b. A linear light source, such as a cold cathode fluorescent lamp (“CCFL”) or a hot cathode fluorescent lamp (“HCFL”) may be used as the light source 153b. A point light source, such as a light emitting diode (“LED”) may be used as the light source 153b. The light source unit 153 may be disposed on a relatively longer side or a relatively shorter side of the light guide plate 152. Two light source units 153 may be respectively disposed at adjacent sides or facing (e.g., opposing) sides of the light guide plate 152. In an exemplary embodiment of the present inventive concept, a plurality of light source units 153 may be respectively disposed on the longer sides of the light guide plate 152, which may face each other.

The light guide plate 152 may have a substantially rectangular-shape, having two long sides and two short sides. The light guide plate 152 may transfer light from the light source unit 153 to the display panel 133. The light guide plate 152 may include a material having a high reflective index and a high transmittance, such as polymethylmethacrylate (“PMMA”), polycarbonate (“PC”) and/or polyethylene (“PE”). These may be used alone or in a mixture thereof.

The reflecting sheet 154 may be disposed under the light guide plate 152. The reflecting sheet 154 may reflect light leaked downward from the light guide plate 152 and toward the light guide plate 152 in an upper direction of the display apparatus 100, so that a luminance may be increased and light may be supplied uniformly. The reflecting sheet 154 may include a material having a high reflective index and a high elasticity, such as a polyester film (e.g., a polyethylene terephthalate (PET) film).

The optical sheets 151 may be disposed on the light guide plate 152. The optical sheets 151 may uniformly transfer light from the light guide plate 152 to the display panel 133. The optical sheets 151 may include a diffusion sheet, a prism sheet and/or a protecting sheet, but the optical sheets 151 are not limited thereto or thereby. The optical sheets 151 may include a transparent resin, such as an acrylic resin, a polyurethane resin or a silicon resin.

The mold frame 160 may be a frame having a rectangular shape and may receive the backlight assembly 150 therein, such as at an open center area of the mold frame 160. The mold frame 160 may include a synthetic resin. The synthetic resin may be an insulator.

The lower receiving container 170 may be disposed under the backlight assembly 150. The lower receiving container 170 may receive and support the display panel 133, the backlight assembly 150 and the mold frame 160 in a receiving space defined therein. The lower receiving container 170 may include aluminum or an aluminum alloy.

The upper receiving container 110 may be disposed on and coupled to the lower receiving container 170. The display panel assembly 130 and the backlight assembly 150 may be disposed between the upper receiving container 110 and the lower receiving container 170. The upper receiving container 110 may define a display region. In an exemplary embodiment of the present inventive concept, an open center area of the upper receiving container 110 may expose a display area or display screen of the display panel 133 and may define the display region. In an exemplary embodiment of the present inventive concept, the upper receiving container 110 may be disposed on and coupled to the lower receiving container 170 by a hook, but the inventive concept is not limited thereto.

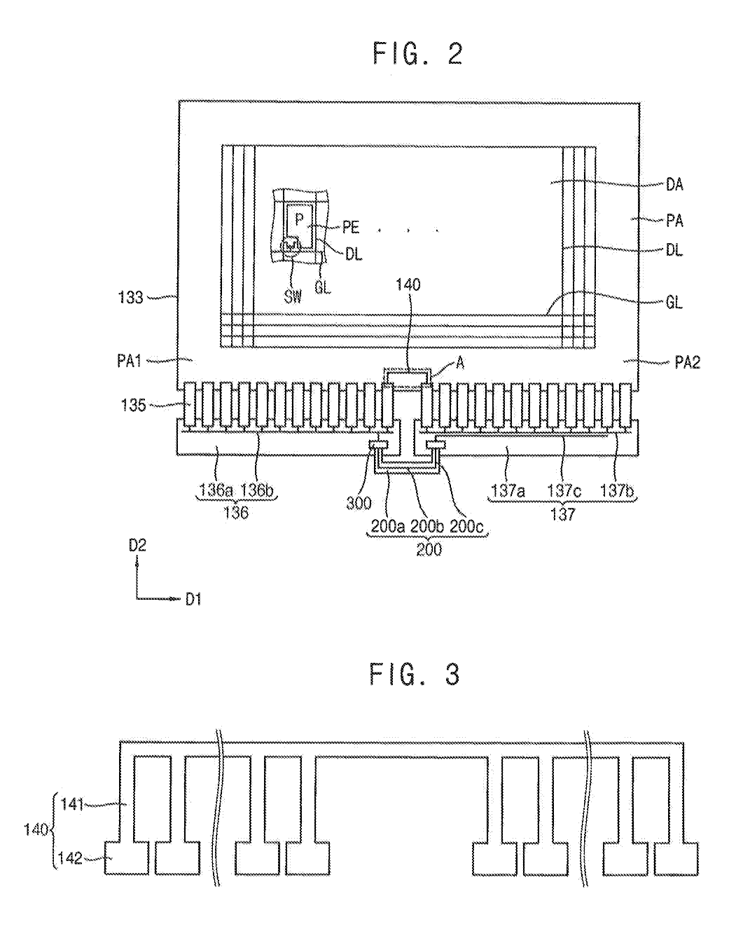

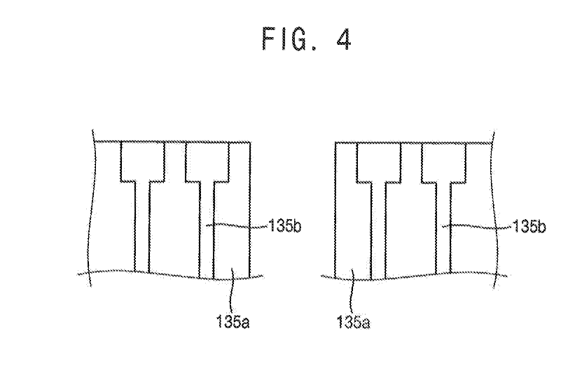

FIG. 2 is a perspective view illustrating the display panel 133 of FIG. 1. FIG. 3 is a plan view magnifying a voltage connecting line of the area ‘A’ of FIG. 2. FIG. 4 is a plan view magnifying a first data driving part and a second data driving part of area ‘A’ of FIG. 2.

Referring to FIGS. 2 to 4, the display panel 133 according to an exemplary embodiment of the present inventive concept may include a display area DA including a pixel area P and a peripheral area PA surrounding the display area DA. The peripheral area PA may include a first peripheral area PA1 and a second peripheral area PA2. A voltage connecting line 140 may be disposed on a boundary between the first peripheral area PA1 and the second peripheral area PA2.

A gate line GL, a data line DL, a pixel switching element SW and a pixel electrode PE may be disposed on the display area DA.

The gate line GL may extend in a first direction D1. The gate line GL may have a single layer structure including copper (Cu), silver (Ag), chrome (Cr), molybdenum (Mo), aluminum (Al), titanium (Ti), manganese (Mn) or an alloy thereof. The gate line GL may have a multi layer structure. The multi layer structure may include a plurality of layers including materials different from each other. For example, the gate line GL may include a copper layer and a titanium layer disposed on and/or under the copper layer.

The data line DL may extend in a second direction D2 crossing the first direction D1. The data line DL may have a single layer structure including copper (Cu), silver (Ag), chrome (Cr), molybdenum (Mo), aluminum (Al), titanium (Ti), manganese (Mn) or an alloy thereof. The data line DL may have a multi layer structure including a plurality of layers including materials different from each other. For example, the data line DL may include a copper layer and a titanium layer disposed on and/or under the copper layer.

The pixel electrode PE may be disposed on the organic layer 140. The pixel electrode PE may include a transparent conductive material, such as indium tin oxide (ITO), or indium zinc oxide (IZO). The pixel electrode PE may include titanium (Ti) and/or molybdenum titanium (MoTi).

A plurality of data driving parts 135 may be electrically connected to the first peripheral area PA1 of the display panel 133. The plurality of data driving parts 135 may be electrically connected to the second peripheral area PA2 adjacent to the first peripheral area PA1 of the display panel 133.

The data driving part 135 may include a base substrate 135a including an insulation material and a plurality of driving lines 135b disposed on the base substrate.

The base substrate 135a may be a flexible substrate. For example, the base substrate 135a may include a flexible film including polyimide, acrylic, polyether nitrile, polyether sulfone, polyethylene terephthalate, polyethylene naphthalate, or polyvinyl chloride.

A printed circuit board may be electrically connected to the data driving part 135. The printed circuit board may include the first printed circuit board 136 and the second printed circuit board 137.

The first printed circuit board 136 may be electrically connected to the data driving parts 135 disposed in the first peripheral area PA1. The second printed circuit board 137 may be electrically connected to the data driving parts 135 disposed in the second peripheral area PA2.

The first printed circuit board 136 may include a first base substrate 136a including an insulation material and a first line 136b disposed on the first base substrate 136a. The first line 136b may be electrically connected to the data driving part 135.

The second printed circuit board 137 may include a second base substrate 137a including a insulation material, a second line 137b disposed on the second base substrate 137a, and a third line 137c disposed on the second base substrate 137a. The second line 137b may be electrically connected to the data driving part 135. The third line 137c may be parallel with the second line 137b.

The connecting circuit board 200 may electrically connect the first printed circuit board 136 to the second printed circuit board 137. The connecting circuit board 200 may electrically connect the first line 136b of the first printed circuit board 136 to the third line 137c of the second printed circuit board 137. An analog driving voltage may be applied to the first line 136b, the second line 137b and the third line 137c.

The connecting circuit board 200 may be connected to the first printed circuit board 136 and the second printed circuit board 137 by the connector 300. The connector 300 may be disposed on the first printed circuit board 136 and the second printed circuit board 137. The connecting part of the connecting circuit board 200 may be inserted into the connector 300 to connect the first printed circuit board 136 to the second printed circuit board 137.

The connecting circuit board 200 may include a third base substrate 200a including a insulation material, a first connecting line 200b disposed on the third base substrate 200a and extending in the first direction D1, and a second connecting line 200c extending in the second direction D2 from an end of the first connecting line 200b. The first connecting line 200b and the second connecting line 200c may be relatively wide. For example, widths of the first connecting line 200b and the second connecting line 200c may be greater than a width of the voltage connecting line 140.

Since, the first connecting line 200b and the second connecting line 200c are relatively wide, the first connecting line 200b and the second connecting line 200c may have a low resistance. Therefore, a voltage drop in the connecting circuit board 200 may be reduced or prevented.

The third base substrate 200a may be a flexible substrate. For example, the third base substrate 200a may be a flexible film including polyimide, acrylic, polyether nitrile, polyether sulfone, polyethylene terephthalate, polyethylene naphthalate, or polyvinyl chloride.

The voltage connecting line 140 may be disposed on the boundary between the first peripheral area PA1 and the second peripheral area PA2. The voltage connecting line 140 may include a plurality of stem portions 141 extending in the second direction D2 and a plurality of pad portions 142. Each pad portion 142 of the plurality of pad portions 142 may be respectively disposed at the end of a stem portion 141 of the plurality of stem portions 141. The voltage connecting line 140 may be disposed in the same layer as the gate line GL. The voltage connecting line 140 may electrically connect the first line 136b and the second line 137b through the driving lines 135b disposed on the base substrate 135a. An analog driving voltage may be applied to the first line 136b, the second line 137b and the third line 137c.

The first line 136b and the third line 137c may be electrically connected to each other by the connecting circuit board 200. The first line 136b and the second line 137b may be electrically connected to each other by the voltage connecting line 140. In other words, the connecting circuit board 200 and the voltage connecting line 140 may be disposed in parallel. Therefore, a voltage drop between the first printed circuit board 136 and the second printed circuit board 137 may be reduced or prevented.

According to the present exemplary embodiment, the first line 136b and the third line 137c may be electrically connected to each other by the connecting circuit board 200. The first line 136b and the second line 137b may be electrically connected to each other by the voltage connecting line 140. Therefore, the first line 136b, the second line 137b and the third line 137c may have a relatively low resistance, so that a voltage drop between the first printed circuit board 136 and the second printed circuit board 137 may be reduced or prevented. Accordingly, the occurrence of a defect in the display panel 133 may be reduced or prevented.

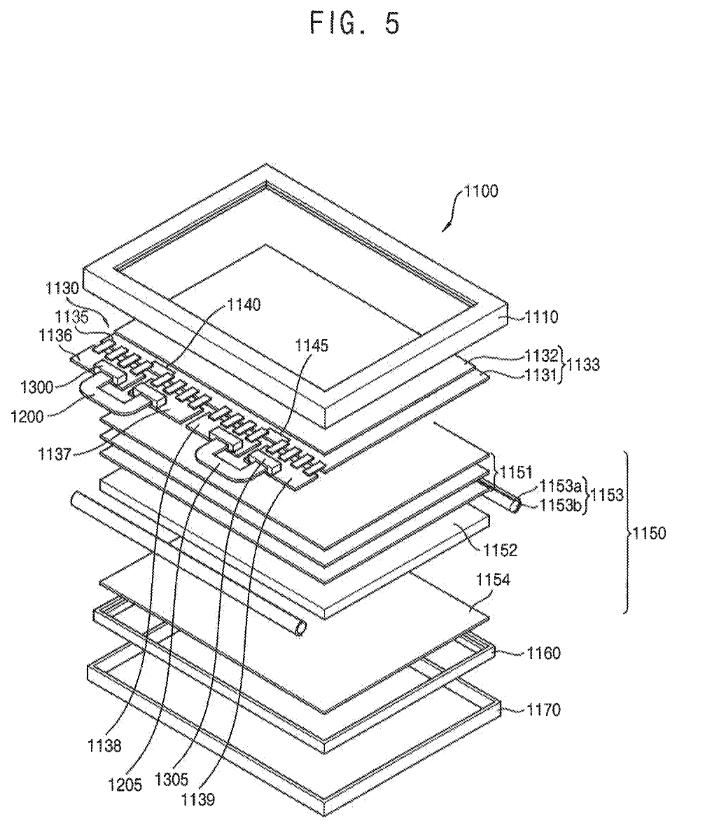

FIG. 5 is a plan view illustrating a display apparatus according to an exemplary embodiment of the present inventive concept.

Referring to FIG. 5, a display apparatus 1100 may include a display panel assembly 1130, a backlight assembly 1150, a mold frame 1160, a lower receiving container 1170 and an upper receiving container 1110.

The display panel assembly 1130 may include a display panel 1133, a data driving part 1135, a first printed circuit board 1136, a second printed circuit board 1137, a third printed circuit board 1138 and a fourth printed circuit board 1139. The display panel 1133 may display an image. The data driving part 1135 may be disposed at an end of the display panel 1133. The data driving part 1135 may drive the display panel 1133. The first printed circuit board 1136, the second printed circuit board 1137, the third printed circuit board 1138 and the fourth printed circuit board 1139 may provide a driving signal and a control signal to the display panel 1133. A first connecting circuit board 1200 may electrically connect the first printed circuit board 1136 and the second printed circuit board 1137. A second connecting circuit board 1205 may electrically connect the third printed circuit board 1138 and the fourth printed circuit board 1139.

The first printed circuit board 1136 and the second printed circuit board 1137 may be electrically connected to each other by the first connecting circuit board 1200. The third printed circuit board 1138 and the fourth printed circuit board 1139 may be electrically connected to each other by the second connecting circuit board 1205. In an exemplary embodiment of the present inventive concept, the first connecting circuit board 1200 and the second connecting circuit board 1205 may each be a flexible printed circuit (“FPC”). The first connecting circuit board 1200 and the second connecting circuit board 1205 may include a flexible and insulating material, such as a polyimide. The first connecting circuit board 1200 and the second connecting circuit board 1205 may include a plurality of conductive lines disposed on a base film. The first connecting circuit board 1200 and the second connecting circuit board 1205 may include a wiring pattern including the conductive lines and a connecting part for connecting to an external apparatus.

The display panel 1133 may include a first display panel 1131 and a second display panel 1132. A liquid crystal layer may be disposed between the first display panel 1131 and the second display panel 1132.

The first display panel 1131 may include one or more gate lines, one or more data lines, a pixel electrode and a thin film transistor. The thin film transistor may be connected to one of the gate lines and one of the data lines. The pixel electrode may be connected to the thin film transistor. A plurality of gate lines may extend in a first direction. Each of the gate lines of the plurality of gate lines may be spaced apart from each other. A plurality of data lines may extend in a second direction. The second direction may cross the first direction. Each of the data lines of the plurality of data lines may be spaced apart from each other. The pixel electrode may be disposed in a pixel region of the display panel 1133. In an exemplary embodiment of the present inventive concept, a pixel region may be defined by the gate lines and the data lines disposed in a matrix form, but the present inventive concept is not limited thereto or thereby. The thin film transistor may be switched (e.g., on and off) by the data line to transfer a signal from the data line to the pixel electrode. The second display panel 1132 may include a light blocking pattern, a red, green and blue (“RGB”) color filter pattern and a common electrode. The light blocking pattern may block a transmission of light in a region of the display panel 1133 except for the pixel region. The RGB color filter pattern may convert the light to colored light. The common electrode may generate an image.

The first display panel 1131 and the second display panel 1132 may be spaced apart from each other in a cross-sectional direction. An optically anisotropic liquid crystal layer may be disposed between first display panel 1131 and the second display panel 1132, but the present inventive concept is not limited to the optically anisotropic liquid crystal layer.

The first printed circuit board 1136, the second printed circuit board 1137, the third printed circuit board 1138 and the fourth printed circuit board 1139 may be disposed at an end of the display panel 1133. The first printed circuit board 1136, the second printed circuit board 1137, the third printed circuit board 1138 and the fourth printed circuit board 1139 may be connected to the display panel 1133 through the data driving part 1135. A driving integrated circuit (“IC”) may be disposed at substantially a center of the data driving part 1135. The driving IC may drive the display panel 1133.

The first printed circuit board 1136, the second printed circuit board 1137, the third printed circuit board 1138 and the fourth printed circuit board 1139 may be electrically connected to the data driving part 1135. The data driving part 1135 may be disposed at a relatively longer side of the display panel 1133. The second printed circuit board 1137 may be adjacent to the first printed circuit board 1136 in a direction parallel to the longer side of the display panel 1133. A plurality of electronic components for generating a driving signal and a control signal may be disposed on the first printed circuit board 1136 and the second printed circuit board 1137. The first connecting circuit board 1200 may electrically connect the first printed circuit board 1136 and the second printed circuit board 1137. The second connecting circuit board 1205 may electrically connect the third printed circuit board 1138 and the fourth printed circuit board 1139.

The first printed circuit board 1136, the second printed circuit board 1137, the third printed circuit board 1138 and the fourth printed circuit board 1139 may be grounded to the upper receiving container 1110 and/or the lower receiving container 1170 to reduce or effectively prevent false operation of the display apparatus 1100 due to electromagnetic wave interference. The first printed circuit board 1136, the second printed circuit board 1137, the third printed circuit board 1138 and the fourth printed circuit board 1139 may be bent along the lower receiving container 1170 to be disposed at a back surface of the lower receiving container 1170 and the display apparatus 1100. The lower receiving container 1170 may include a metal material. When the first printed circuit board 1136, the second printed circuit board 1137, the third printed circuit board 1138 and the fourth printed circuit board 1139 are bent along the lower receiving container 1170, an extent of the grounding may be increased.

The first connecting circuit board 1200 may be connected to the first printed circuit board 1136 and the second printed circuit board 1137 by a first connector 1300. The second connecting circuit board 1205 may be connected to the third printed circuit board 1138 and the fourth printed circuit board 1139 by a second connector 1305. The first connector 1300 may be disposed on the first printed circuit board 1136 and the second printed circuit board 1137. A connecting part of the first connecting circuit board 1200 may be inserted into the first connector 1300 to connect the first printed circuit board 1136 and the second printed circuit board 1137.

The first connecting circuit board 1200 may be connected to the first printed circuit board 1136 and the second printed circuit board 1137 by an anisotropic conductive film (“ACF”).

As described above, the first connecting circuit board 1200 may be connected to the first printed circuit board 1136 and the second printed circuit board 1137 by the first connector 1300, but the present inventive concept is not limited thereto. In an exemplary embodiment of the present inventive concept, the first connecting circuit board 1200 may be connected to the first printed circuit board 1136 and the second printed circuit board 1137 by a connector assembly.

The backlight assembly 1150, which may generate and provide light to the display panel 1133, may be disposed under the display panel 1133 in the cross-sectional direction. The backlight assembly 1150 may include one or more light source units 1153, a light guide plate 1152, a reflecting sheet 1154 and a plurality of optical sheets 1151.

The light source unit 1153 may be disposed on a side of the light guide plate 1152, and may face a side surface of the light guide plate 1152. The light source unit 1153 may include one or more light source 1153b generating and providing light, and one or more light source cover 1153a covering the light source 1153b. A linear light source, such as a cold cathode fluorescent lamp (“CCFL”) or a hot cathode fluorescent lamp (“HCFL”) may be used as the light source 1153b. Alternatively, a point light source, such as a light emitting diode (“LED”) may be used as the light source 1153b. The light source unit 1153 may be disposed at a relatively longer side or a relatively shorter side of the light guide plate 1152. Two light source units 1153 may be respectively disposed on adjacent sides or facing (e.g., opposing) sides of the light guide plate 1152. In an exemplary embodiment of the present inventive concept, a plurality of light source units 1153 may be respectively disposed on the longer sides of the light guide plate 1152, which may face each other.

The light guide plate 1152 may have a substantially rectangular-shape, having two long sides and two short sides. The light guide plate 1152 may transfer light from the light source unit 1153 to the display panel 1133. The light guide plate 1152 may include a material having a high reflective index and a high transmittance, such as polymethylmethacrylate (“PMMA”), polycarbonate (“PC”) and/or polyethylene (“PE”). These may be used alone or in a mixture thereof.

The reflecting sheet 1154 may be disposed under the light guide plate 1152. The reflecting sheet 1154 may reflect light leaked downward from the light guide plate 1152 and toward the light guide plate 1152 in an upper direction of the display apparatus 1100, so that a luminance may be increased and a light may be supplied uniformly. The reflecting sheet 1154 may include a material having a high reflective index and a high elasticity, such as a polyester film (e.g., a polyethylene terephthalate (PET) film).

The optical sheets 1151 may be disposed on the light guide plate 1152. The optical sheets 1151 may uniformly transfer light from the light guide plate 1152 to the display panel 1133. The optical sheets 1151 may include a diffusion sheet, a prism sheet and a protecting sheet, but the optical sheets 151 are not limited thereto or thereby. The optical sheets 1151 may include a transparent resin, such as an acrylic resin, a polyurethane resin or a silicon resin.

The mold frame 1160 may be a frame having a rectangular shape and may receive the backlight assembly 1150 therein, such as at an open center area of the mold frame 1160. The mold frame 1160 may include a synthetic resin. The synthetic resin may be an insulator.

The lower receiving container 1170 may be disposed under the backlight assembly 1150. The lower receiving container 1170 may receive and support the display panel 1133, the backlight assembly 1150 and the mold frame 1160 in a receiving space defined therein. The lower receiving container 1170 may include aluminum or an aluminum alloy.

The upper receiving container 1110 is may be disposed on and coupled to the lower receiving container 1170. The display panel assembly 1130 and the backlight assembly 1150 may be disposed between the upper receiving container 1110 and the lower receiving container 11170. The upper receiving container 1110 may define a display region. In an exemplary embodiment of the present inventive concept, an open center area of the receiving container 1110 may expose a display area or display screen of the display panel 1133 and may define the display region. In an exemplary embodiment of the present inventive concept, the upper receiving container 1110 may be disposed on and coupled to the lower receiving container 1170 by a hook, but the present inventive concept is not limited thereto.

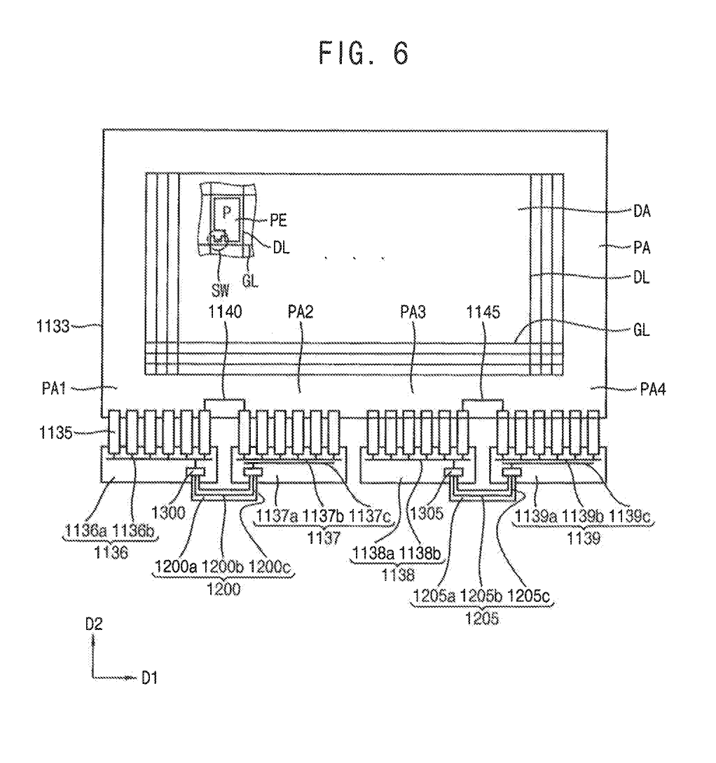

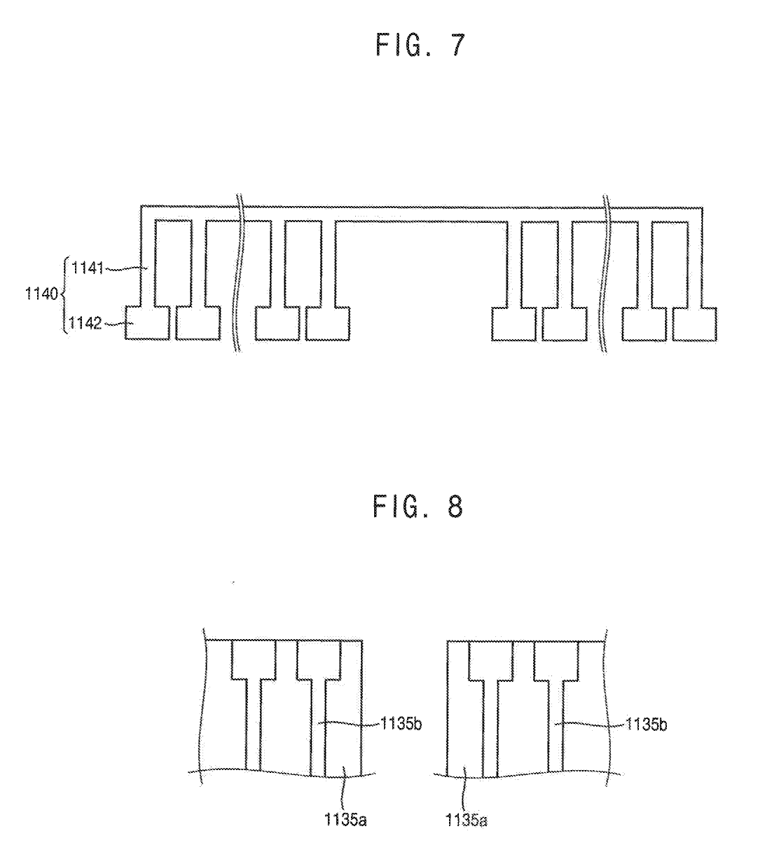

FIG. 6 is a perspective view illustrating the display panel 133 of FIG. 5. FIG. 7 is a plan view magnifying a voltage connecting line of the area ‘B’ of FIG. 6. FIG. 8 is a plan view magnifying a first data driving part and a second data driving part of the area ‘B’ of FIG. 6.

Referring to FIGS. 6 to 8, the display panel 1133 according to an exemplary embodiment of the present inventive concept may include a display area DA including a pixel area P and a peripheral area PA surrounding the display area DA. The peripheral area PA may include a first peripheral area PA1, a second peripheral area PA2, a third peripheral area PA3 and a fourth peripheral area PA4. A first voltage connecting line 1140 may be disposed on a boundary between the first peripheral area PA1 and the second peripheral area PA2. A second voltage connecting line 1145 may be disposed on a boundary between the third peripheral area PA3 and the fourth peripheral area PA4.

A gate line GL, a data line DL, a pixel switching element SW and a pixel electrode PE may be disposed on the display area DA.

The gate line GL may extend in the first direction D1. The gate line GL may have a single layer structure including copper (Cu), silver (Ag), chrome (Cr), molybdenum (Mo), aluminum (Al), titanium (Ti), manganese (Mn) or an alloy thereof. The gate line GL may have a multi layer structure. The multi layer structure may include a plurality of layers including materials different from each other. For example, the gate line GL may include a copper layer and a titanium layer disposed on and/or under the copper layer.

The data line DL may extend in a second direction D2 crossing the first direction D1. The data line DL may have a single layer structure including copper (Cu), silver (Ag), chrome (Cr), molybdenum (Mo), aluminum (Al), titanium (Ti), manganese (Mn) or an alloy thereof. The data line DL may have a multi layer structure including a plurality of layers including materials different from each other. For example, the data line DL may include a copper layer and a titanium layer disposed on and/or under the copper layer.

The pixel electrode PE may be disposed on the organic layer 140. The pixel electrode PE may include a transparent conductive material, such as indium tin oxide (ITO), or indium zinc oxide (IZO). The pixel electrode PE may include titanium (Ti) and/or molybdenum titanium (MoTi).

A plurality of data driving parts 1135 may be electrically connected to the first peripheral area PA1 of the display panel 1133. A plurality of data driving parts 1135 may be electrically connected to the second peripheral area PA2 adjacent to the first peripheral area PA1 of the display panel 1133. A plurality of data driving parts 1135 may be electrically connected to the third peripheral area PA3 adjacent to the second peripheral area PA2 of the display panel 1133. A plurality of data driving parts 1135 may be electrically connected to the fourth peripheral area PA4 adjacent to the third peripheral area PA3 of the display panel 1133.

The data driving part 1135 may include a base substrate 1135a including an insulation material and a plurality of driving lines 1135b disposed on the base substrate 1135a.

The base substrate 1135a may be a flexible substrate. For example, the base substrate 1135a may be a flexible film including polyimide, acrylic, polyether nitrile, polyether sulfone, polyethylene terephthalate, polyethylene naphthalate, or polyvinyl chloride.

A printed circuit board may be electrically connected to the data driving part 1135. The printed circuit board may include the first printed circuit board 1136, the second printed circuit board 1137, the third printed circuit board 1138 and the fourth printed circuit board 1139.

The first printed circuit board 1136 may be electrically connected to the data driving parts 1135 disposed in the first peripheral area PA1. The second printed circuit board 1137 may be electrically connected to the data driving parts 1135 disposed in the second peripheral area PA2. The third printed circuit board 1138 may be electrically connected to the data driving parts 1135 disposed in the third peripheral area PA3. The fourth printed circuit board 1139 may be electrically connected to the data driving parts 1135 disposed in the fourth peripheral area PA4.

The first printed circuit board 1136 may include a first base substrate 1136a including an insulation material and a first line 1136b disposed on the first base substrate 1136a. The first line 1136b may be electrically connected to the data driving part 1135.

The second printed circuit board 1137 may include a second base substrate 1137a including a insulation material, a second line 1137b disposed on the second base substrate 1137a, and a third line 1137c disposed on the second base substrate 1137a. The second line 1137b may be electrically connected to the data driving part 1135. The third line 1137c may be parallel with the second line 11376.

The third printed circuit board 1138 may include a third base substrate 1138a including an insulation material and a first line 1138b disposed on the third base substrate 1138a. The first line 1138b may be electrically connected to the data driving part 1135.

The fourth printed circuit board 1139 may include a fourth base substrate 1139a including an insulation material, a second line 1139b disposed on the fourth base substrate 1139a, and a third line 1139c disposed on the fourth base substrate 1139a. The second line 1139b may be electrically connected to the data driving part 1135. The third line 1139c may be parallel with the second line 1139b.

The first connecting circuit board 1200 may electrically connect the first printed circuit board 1136 and the second printed circuit board 1137. The first connecting circuit board 1200 may electrically connect the first line 1136b of the first printed circuit board 1136 and the third line 1137c of the second printed circuit board 1137. An analog driving voltage may be applied to the first line 1136b, the second line 1137b and the third line 1137c.

The second connecting circuit board 1205 may electrically connect the third printed circuit board 1138 and the fourth printed circuit board 1139. The second connecting circuit board 1205 may electrically connect the first line 1138b of the third printed circuit board 1138 and the third line 1139c of the fourth printed circuit board 1139. An analog driving voltage may be applied to the first line 1138b, the second line 1139b and the third line 1139c.

The first connecting circuit board 1200 may be connected to the first printed circuit board 1136 and the second printed circuit board 1137 by a connector 1300. The connector 1300 may be disposed on the first printed circuit board 1136 and the second printed circuit board 1137. A connecting part of the first connecting circuit board 1200 may be inserted into the connector 1300 to connect the first printed circuit board 1136 to the second printed circuit board 1137.

The first connecting circuit board 1200 may include a third base substrate 1200a including a insulation material, a first connecting line 1200b disposed on the third base substrate 1200a and extending in the first direction D1, and a second connecting line 1200c extending in the second direction D2 from an end of the first connecting line 1200b. The first connecting line 1200b and the second connecting line 1200c may be relatively wide. For example, widths of the first connecting line 1200b and the second connecting line 1200c may be greater than a width of the first voltage connecting line 1140.

Since, the first connecting line 1200b and the second connecting line 1200c are relatively wide, the first connecting line 1200b and the second connecting line 1200c may have a low resistance. Therefore, a voltage drop in the first connecting circuit board 1200 may be reduced or prevented.

The third base substrate 1200a may be a flexible substrate. For example, the third base substrate 1200a may be a flexible film including polyimide, acrylic, polyether nitrile, polyether sulfone, polyethylene terephthalate, polyethylene naphthalate, or polyvinyl chloride.

The second connecting circuit board 1205 may include a third base substrate 1205a including a insulation material, a first connecting line 1205b disposed on the third base substrate 1205a and extending in the first direction D1, and a second connecting line 1205c extending in the second direction D2 from an end of the first connecting line 1205b. The first connecting line 1205b and the second connecting line 1205c may be relatively wide. For example, widths of the first connecting line 1205b and the second connecting line 1205c may be greater than a width of the second voltage connecting line 1145.

Since, the first connecting line 1205b and the second connecting line 1205c have are relatively wide, the first connecting line 1205b and the second connecting line 1205c have a low resistance. Therefore, a voltage drop in the second connecting circuit board 1205 may be reduced or prevented.

The third base substrate 1205a may be a flexible substrate. For example, the third base substrate 1205a may be a flexible film including polyimide, acrylic, polyether nitrile, polyether sulfone, polyethylene terephthalate, polyethylene naphthalate, or polyvinyl chloride.

The first voltage connecting line 1140 may be disposed on a boundary between the first peripheral area PA1 and the second peripheral area PA2. The first voltage connecting line 1140 may include a plurality of stem portions 1141 extending in the second direction and a plurality of pad portions 1142 disposed at the end of the stem portions 1141. The first voltage connecting line 1140 may be disposed in the same layer as the gate line GL. The first voltage connecting line 1140 may electrically connect the first line 1136b and the second line 1137b through the driving lines 1135b disposed on the base substrate 1135a. An analog driving voltage may be applied to the first line 1136b, the second line 1137b and the third line 1137c.

The second voltage connecting line 1145 may be disposed on a boundary between the third peripheral area PA3 and the fourth peripheral area PA4. The second voltage connecting line 1145 may be disposed in the same layer as the gate line GL. The second voltage connecting line 1145 may electrically connect the first line 1138b and the second line 1139b through the driving lines 1135b disposed on the base substrate 1135a. An analog driving voltage may be applied to the first line 1138b, the second line 1139b and the third line 1139c.

The first line 1136b and the third line 1137c may be electrically connected to each other by the first connecting circuit board 1200. The first line 1136b and the second line 1137b may be electrically connected to each other by the first voltage connecting line 1140. In other words, the first connecting circuit board 1200 and the first voltage connecting line 1140 may be disposed in parallel. Therefore, a voltage drop between the first printed circuit board 1136 and the second printed circuit board 1137 may be reduced or prevented.

The first line 1138b and the third line 1139c may be electrically connected to each other by the second connecting circuit board 1205. The first line 1138b and the second line 1139b may be electrically connected to each other by the second voltage connecting line 1145. In other words, the second connecting circuit board 1205 and the second voltage connecting line 1145 may be disposed in parallel. Therefore, a voltage drop between the third printed circuit board 1138 and the fourth printed circuit board 1139 may be reduced or prevented.

According to an exemplary embodiment of the present inventive concept, the first line 1136b and the third line 1137c may be electrically connected to each other by the first connecting circuit board 1200. The first line 1136b and the second line 1137b may be electrically connected to each other by the first voltage connecting line 1140. Therefore, the first line 1136b, the second line 1137b and the third line 1137c may have a low resistance, so that a voltage drop between the first printed circuit board 1136 and the second printed circuit board 1137 may be reduced or prevented. Accordingly, the occurrence of defects in the display panel 1133 may be reduced or prevented.

The first line 1138b and the third line 1139c may be electrically connected to each other by the second connecting circuit board 1205. The first line 1138b and the second line 1139b may be electrically connected to each other by the second voltage connecting line 1145. Therefore, the first line 1138b, the second line 1139b and the third line 1139c may have a low resistance, so that a voltage drop between the third printed circuit board 1138 and the fourth printed circuit board 1139 may be reduced or prevented. Accordingly, the occurrence of defects in the display panel 1133 may be reduced or prevented.

According to an exemplary embodiment of the present inventive concept, a first line of a first printed circuit board and a second line of a second printed circuit board may be electrically connected to each other by a voltage connecting line. The first line of the first printed circuit board and a third line of the second printed circuit board may be electrically connected to each other by a connecting circuit board. Therefore, the first line, the second line and the third line may have a low resistance.

In addition, the first line, the second line and the third line may have a low resistance, so that a voltage drop between the first printed circuit board and the second printed circuit board may be reduced or prevented. Accordingly, the occurrence of defects in a display panel may be reduced or prevented.

While the present inventive concept has been particularly shown and described with reference to exemplary embodiments thereof, it will be understood by those of ordinary skill in the art that various changes in form and detail may be made therein without departing from the spirit and scope of the present inventive concept as defined by the following claims.

What is claimed is:

1. A display apparatus comprising:
a display panel comprising a gate line disposed in a display area and extending in a first direction, a data line extending in a second direction crossing the first direction, and a switching element electrically connected to the gate line and the data line;
a first data driving part electrically connected to a first peripheral area adjacent to the display area; and
a second data driving part electrically connected to a second peripheral area adjacent to the first peripheral area,
wherein the display panel further comprises a voltage connecting line disposed between the first peripheral area and the second peripheral area, and wherein the voltage connecting line connects the first data driving part to the second data driving part.

2. The display apparatus of claim 1, wherein the voltage connecting line is disposed in the same layer as the gate line.

3. The display apparatus of claim 1, wherein the first and the second data driving parts each comprise:
a base substrate; and
a plurality of driving lines disposed on the base substrate.

4. The display apparatus of claim 3, wherein the base substrate is a flexible substrate.

5. The display apparatus of claim 1, further comprising:
a first printed circuit board electrically connected to the first data driving part; and
a second printed circuit board disposed adjacent to the first printed circuit board, wherein the second printed circuit board is electrically connected to the second data driving part.

6. The display apparatus of claim 5, wherein the first printed circuit board comprises:
a first base substrate; and
a first line disposed on the first base substrate, wherein the first line is electrically connected to the first data driving part.

7. The display apparatus of claim 6, wherein the second printed circuit board comprises:
a second base substrate;
a second line, wherein the second line is electrically connected to the second data driving part; and
a third line disposed on the second base substrate, wherein the third line is parallel with the second line.

8. The display apparatus of claim 7, wherein the voltage connecting line connects the first line and the second line.

9. The display apparatus of claim 7, further comprising:
a connecting circuit board connecting the first printed circuit board and the second printed circuit board.

10. The display apparatus of claim 9, wherein the connecting circuit board connects the first line and the third line.

11. The display apparatus of claim 10, wherein the first line, the second line and the third line are configured to receive an analog driving voltage.

12. The display apparatus of claim 9, wherein the first printed circuit board further comprises a first connector disposed on the first base substrate, and the second printed circuit board further comprises a second connector disposed on the second base substrate.

13. The display apparatus of claim 12, wherein the connecting circuit board comprises:
a third base substrate; and
a connecting line disposed on the third base substrate.

14. The display apparatus of claim 13, wherein the third base substrate is a flexible substrate.

15. The display apparatus of claim 13, wherein the connecting line comprises:
a first connecting line extending in the first direction; and
a second connecting line extending in the second direction from an end of the first connecting line.

16. The display apparatus of claim 13, wherein a width of the connecting line is greater than a width of the voltage connecting line.

17. The display apparatus of claim 1, further comprising:
a backlight assembly disposed under the display panel.

18. The display apparatus of claim 17, wherein the backlight assembly comprises:
a light source configured to emit light; and
a light guide plate configured to guide the light emitted from the light source.

19. The display apparatus of claim 17, further comprising:
a mold frame configured to receive the backlight assembly.

20. The display apparatus of claim 16, further comprising:
a lower receiving container configured to receive the display panel and the backlight assembly.
